(19) United States
(12) Patent Application Publication
(10) Pub. No.: US 2008/0313644 A1
(43) Pub. Date: Dec. 18, 2008

(54) SYSTEM ANALYSIS APPARATUS AND SYSTEM ANALYSIS METHOD

(75) Inventor: Teruyoshi Zemmyo, Kawasaki-shi (JP)

Correspondence Address: Charles N.J. Ruggiero, Esq.;Ohlandt , Greeley, Ruggiero & Perle, L.L.P., 10th Floor, One Landmark Square, Stamford, CT, 06901-2682, US

(73) Assignee: KABUSHIKI KAISHA TOSHIBA

(21) Appl. No.: 12/051,591

(22) Filed: Mar. 19, 2008

(30) Foreign Application Priority Data
Jun. 15, 2007 (JP) 2007-159283

(51) Int. Cl. G06F 9/46

(52) U.S. Cl. 718/108

(57) ABSTRACT

For an information system to be analyzed, restriction information indicating a restriction to be satisfied in the case where the information system is normal is acquired, and an anomalous state failing to satisfy the restriction is specified in a state transition model involving only the automatic transition. Also, the transition from an anomalous state to a normal state is retrieved in the state transition model involving only the manual transition thereby to output management work information indicating a management work specified by the retrieved manual transition as related to the anomalous state.

### CROSS-REFERENCE TO RELATED APPLICATIONS

This application is based upon and claims the benefit of priority from prior Japanese Patent Application No. 2007-159283, filed Jun. 15, 2007, the entire contents of which are incorporated herein by reference.

### BACKGROUND OF THE INVENTION

1. Field of the Invention

The present invention relates to an apparatus and a method for analyzing a fault which may occur in an information system and the management work needed upon the occurrence of the fault.

2. Description of the Related Art

The recent complication of information systems has posed the problem of an increased management cost of information systems. In view of this, a research is underway for a self-management system with the aim of reducing the management cost of an information system by causing the information system to manage itself (see, for example, “What is Autonomic Computing?”, SoftBank Publishing, ISBN: 4797330376”).

The self-management system realizes automation of the management work required for a fault based on, for example, information on a fault detection method and a repairing method (hereinafter referred to as “operation knowledge”). The operation knowledge is arranged in the self-management system and requires maintenance and control. In the case where the configuration of a system involved undergoes a change or a trouble-shooting method not included in the initial operation knowledge is found, for example, the operation knowledge is required to be corrected.

As a method of maintenance and control of the operation knowledge in the self-management system, a distributed management type self-healing technique has been conceived (see, for example, JP-A 2007-128185 (KOKAI) and “A self-healing technique based on encapsulated operation knowledge, Proceedings of the 3rd IEEE International Conference on Autonomic Computer (ICAC'06), June 2006”). In this technique, the operation knowledge is expressed for each component making up a constituent element of the information system in a form independent of a specified system configuration or other components. As a result, the modularity of the operation knowledge for each component is improved and the maintenance thereof facilitated.

A system using the distributed management type self-healing technique (hereinafter referred to as “the distributed management type self-repairing system”) is constructed by combining the operation knowledge for each component thereby to perform the self-healing operation. Nevertheless, the operation knowledge for the components, which are independent of each other and managed separately from each other, may undergo a change. In such a case, the self-healing operation cannot be grasped with the distributed management type self-healing system constructed by combining the operation knowledge. Specifically, the distributed management type self-healing system is unable to verify the legitimacy of the self-healing operation, and therefore, poses the problem that it cannot be used for a system requiring a high reliability.

In order to verify that the self-repairing operation is legitimate, it is necessary to grasp a fault that may occur in the information system to be analyzed and to confirm that the appropriate management work is related to each fault. Specifically, the analysis of a fault and the management work regarding the fault in the information system to be analyzed is required.

In one method of analyzing a fault that may occur in the information system, an application of the analysis method based on a state transition model may be considered (see, for example, “Concurrency State Models & Java (registered trademark) Programming, Jeff Magee and Jeff Kramer, John Wiley & Sons Inc.”).

In the conventional system analysis method based on the state transition model, however, automatic transition caused by execution of the functions of the information system and manual transition caused by the artificial operation performed by the human system manager or the like are not distinguished from each other, and therefore, the problem is posed that the relation between a fault and the management work required for the fault is not clear.

Also, in the information system capable of various processes and manual operation, the state transition model to be analyzed is so large in scale and complicated that a long time may be required for fault analysis, on top of the high cost and capacity of the storage unit.

### BRIEF SUMMARY OF THE INVENTION

According to an aspect of the present invention, there is provided a system analysis apparatus for an information system to be analyzed, comprising: a storage unit which stores state information indicating a plurality of states of the system identified by state identifiers, and transition information including state transition information indicating a transition between said plurality of states and classification information indicating whether the transition is an automatic one or a manual one; an analysis unit configured to acquire restriction information indicating a restriction to be satisfied in the case where the information system is normal and to specify an anomalous state of the information system failing to satisfy the restriction based on the restriction information acquired and the transition information; and an output unit configured to retrieve the transition from the anomalous state specified by the analysis unit to the normal state, based on the state information and the transition information, to generate a management work with reference to the retrieval result, and to output management work information indicating the generated management work as related to the anomalous state.

### BRIEF DESCRIPTION OF THE SEVERAL VIEWS OF THE DRAWING

FIG. 1 is a diagram showing a normal state of an information system to be analyzed by an information system analysis apparatus;

FIG. 2 is a diagram showing an anomalous state of an information system to be analyzed by an information system analysis apparatus;

FIG. 3 is a diagram showing an information system using a distributed management type self-repairing technique;

FIG. 4 is a block diagram showing an information system analysis apparatus according to an embodiment;

FIG. 5 is a diagram showing an example of module information;

FIG. 6 is a diagram showing state information of a server module;

FIG. 7 is a diagram showing transition information of a server module;

FIG. 8 is a state transition diagram of a server module;

FIG. 9 is a state transition diagram of a client module;

FIG. 10 is a flowchart showing the steps of an analysis process executed by an information system analysis apparatus;

FIG. 11 is a diagram for explaining that the information to be analyzed is input through a GUI;

FIG. 12 is a diagram for explaining that the information to be analyzed is input through the GUI;

FIG. 13 is a diagram for explaining that the information to be analyzed is input through the GUI;

FIG. 14 is a diagram for explaining that the information to be analyzed is input through the GUI;

FIG. 15 is a diagram for explaining that the information to be analyzed is input through the GUI;

FIG. 16 is a flowchart showing the steps of a process for analyzing an anomalous state;

FIG. 17 is a diagram showing an automatic state transition model of a server module;

FIG. 18 is a diagram showing an automatic state transition model of a client module;

FIG. 19 is a diagram showing the synthesis of the automatic state transition models;

FIG. 20 is a diagram showing state classification information;

FIG. 21 is a flowchart showing the steps of a process for analyzing a management work;

FIG. 22 is a diagram showing a manual state transition model of a server module;

FIG. 23 is a diagram showing a manual state transition model of a client module;

FIG. 24 is a diagram showing the synthesis of the manual state transition models; and

FIG. 25 is a diagram showing management work information.

### DETAILED DESCRIPTION OF THE INVENTION

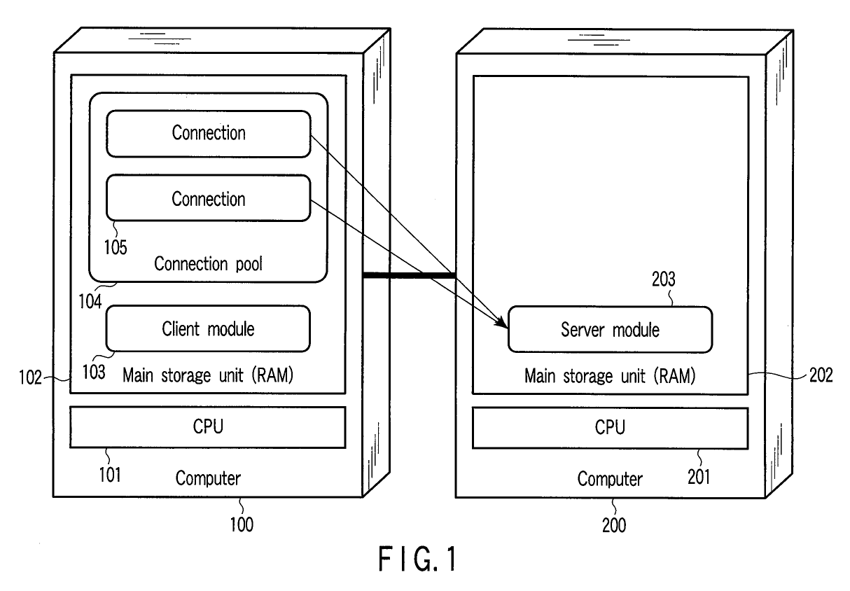

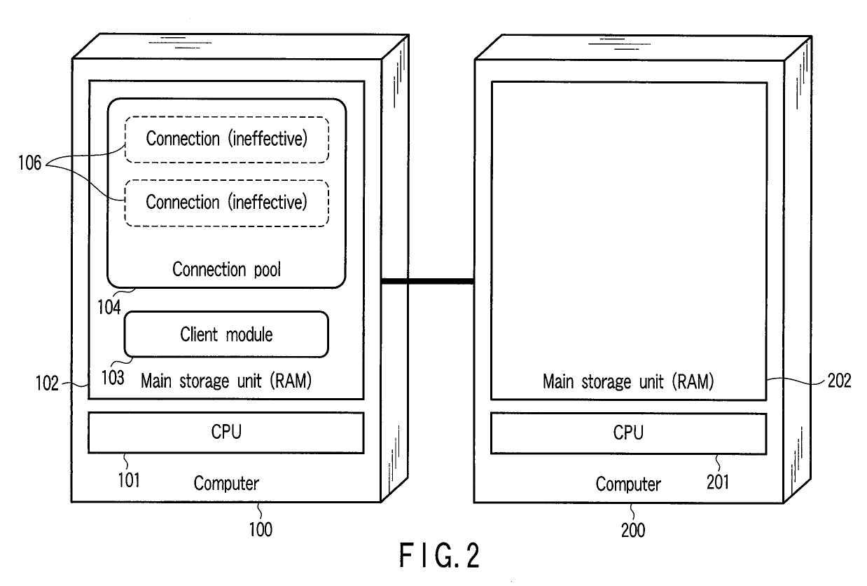

First, with reference to FIGS. 1 and 2, an information system to be analyzed by an information system analysis apparatus according to an embodiment will be explained. FIG. 1 shows, an information system including, for example, two computers, i.e. computers 100 and 200. The computer 100 includes a CPU 101 and a main storage unit 102, and the computer 200 similarly includes a CPU 201 and a main storage unit 202. The main storage unit 102 of the computer 100 includes a client module 103, and the main storage unit 202 of the computer 200 includes a server module 203. The client module 103 has a connection pooling function. The connection pooling function makes it possible to hold network connections established with the destinations of communication on a storage unit and freely used among a plurality of processes in a communication program (module). Since the connections are freely used by a plurality of processes, all the processes can be executed at a higher speed by reducing the number of times the connections are initialized.

In FIG. 1, connections 105 between the client module and the server module arranged on the computer 200 are held in a connection pool 104 formed on the main storage unit 102 of the computer 100. In order that the connections 105 held on the connection pool 104 of the computer 100 may be effective, the server module 203 arranged on the computer 200 is required to be kept in operation.

FIG. 2 shows the state of the information system after the server module 203 shown in FIG. 1 has stopped. The server module, which is the destination of communication with connections 106 held on the computer 100, does not exist in the main storage unit 202 of the computer 200. Therefore, the connections 106 held on the computer 100 are ineffective. Also, even in the case where the server module is restarted in the state shown in FIG. 2, the connections 106 remain ineffective. In the case where the client module 103 makes an attempt to execute the process required for communication with the sever module with the ineffective connections 106 held as shown in FIG. 2, the ineffective connections 106 held would be used, and therefore, the process cannot be normally completed. In other words, the state shown in FIG. 2 is one of anomalous states (faults) of the information system to be analyzed by the information system analysis apparatus according to this embodiment.

The transition from the anomalous state shown in FIG. 2 to the normal state, i.e. the state in which the process of the client module 103 can be completed normally requires the management work described below.

(1) The server module 203 on the computer 200 is restarted.

(2) The ineffective connections 106 held on the computer 100 are erased.

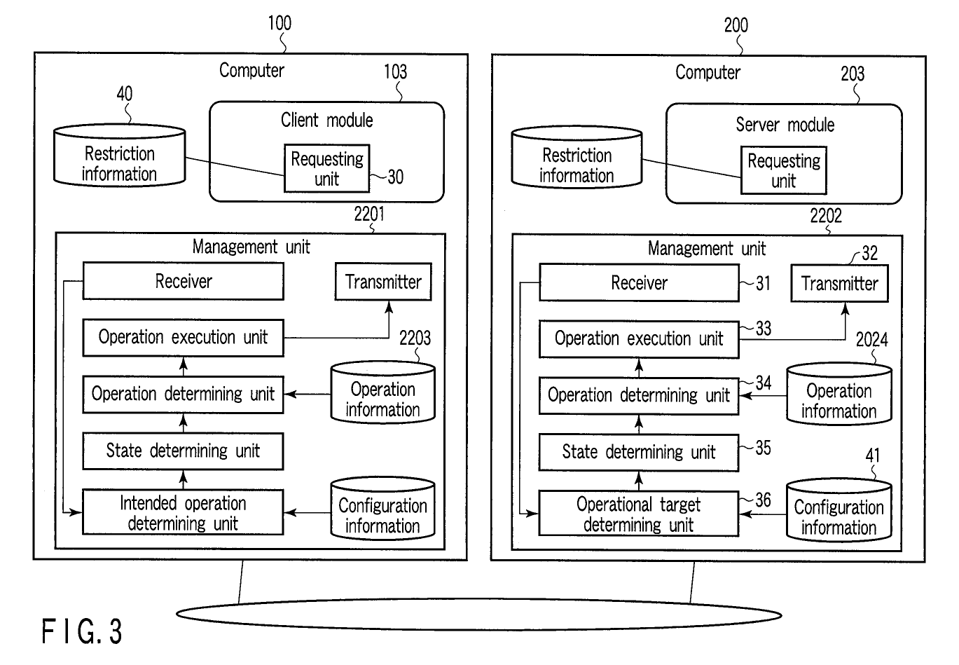

FIG. 3 shows a configuration in which the distributed management type self-healing technique is applied to the system shown in FIG. 1. A requesting unit 30 searches a restriction information DB 40 for constraint information corresponding to the process executed in the client module 103. Based on this constraint information, the computer on which the client module 103 is dependent, i.e. an intended computer (the computer 200 in the case under consideration) is specified. In other words, the state of the intended computer required for executing the process of the client 103 is specified based on the constraint information.

A receiver 31 in a management unit 2202, on the other hand, receives a transit instruction from an external source through a network. The transit instruction is defined as the information indicating that a predetermined function is set in a predetermined state, e.g. the information that the server module 203 is set in the activated state. Also, the receiver 31 specifically receives the information from the computer 100 dependent on the computer 200.

An operational target determining unit 36 specifies a function indicated in the transit instruction received by the receiver 31. In the process, the information contained in configuration information 41 is referred to. The configuration information 41 contains function information. The function information is defined as the information for relating the server module 203 installed in the computer 200 to the function realized by the server module 203.

A state determining unit 35 specifies the present state corresponding to the function specified by the operational target determining unit 36. In the process, the information contained in operation information 2204 is referred to. The operation information 2204 contains the state information of each function. The state information is defined as the information indicating the process state, such as the standby or activation of each function. The information indicating the present state of each function is also held therein.

An operation determining unit 34 specifies the process for transition from the present state specified by the state determining unit 35 to the state indicated in the transit instruction. In the process, the information contained in the operation information 2204 is referred to. An operation execution unit 33 executes the process specified by the operation determining unit 34 and causes the transition of the function indicated in the transit instruction to the state indicated in the transit instruction.

A transmitter 32, upon completion of the process of the operation execution unit 33, transmits a completion notice indicating that the transition to the state indicated in the transit instruction has been completed, to the transit instruction source.

A distributed management type self-repairing system (management apparatus) 2201 of the computer 100 is constructed similarly to the distributed management type self-repairing system (management apparatus) 2202 of the computer 200 described above.

The distributed management type self-repairing systems 2201, 2202 realize the self-reparation based on the operation information 2203, 2204. In order to secure the proper self-repairing operation in the distributed management type self-repairing systems 2201, 2202, a fault and the management work involved in repairing the particular fault are required to be properly described in the operation information 2203, 2204.

The confirmation of propriety of the operation information 2203, 2204 involves the following two requirements:

(a) A fault that may occur in the system shown in FIG. 1 and the management work involved in repairing the fault shall be clearly defined.

(b) The method of detecting the fault in (a) and the management work in (a) shall be contained in the operation information 2203, 2204.

The present embodiment relates to (a) above and permits the system manager, etc. to definitely recognize that the construction of the information system shown in FIG. 1 by combining the client module 103 with the server module 203 may be accompanied by the anomalous state as shown in FIG. 2 and that the management work described above is required to restore from the anomalous state shown in FIG. 2.

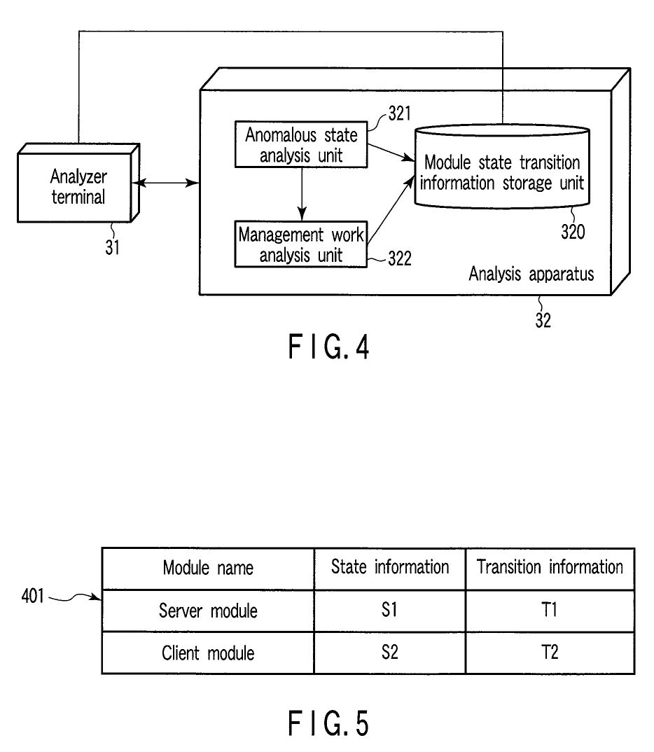

In FIG. 4, the user of the information system analysis apparatus 32 is a system manager, for example, who transmits the information to be analyzed on the intended information system to the information system analysis apparatus 32 using an analyzer terminal 31. The information system analysis apparatus 32 includes an anomalous state analysis unit 321, a management work analysis unit 322 and a module state transition information storage unit 320. The information system analysis apparatus 32, upon reception of the information to be analyzed from the analyzer terminal 31, analyzes the information to be analyzed and transmits the analysis result to the analyzer terminal 31. The analysis result thus transmitted is displayed by the analyzer terminal 31.

Next, the information stored in the module state transition information storage unit 320 will be explained. The module state transition information storage unit 320 stores three types of information, including, (1) module information, (2) state information and (3) transition information. FIG. 5 shows an example of the module information. The module information relates the module name, the state information and the transition information to each other. Specifically, in data 401 of the module information, the state information of the server module 203 is specified by an identifier S1 and the transition information of the server module 203 by an identifier T1.

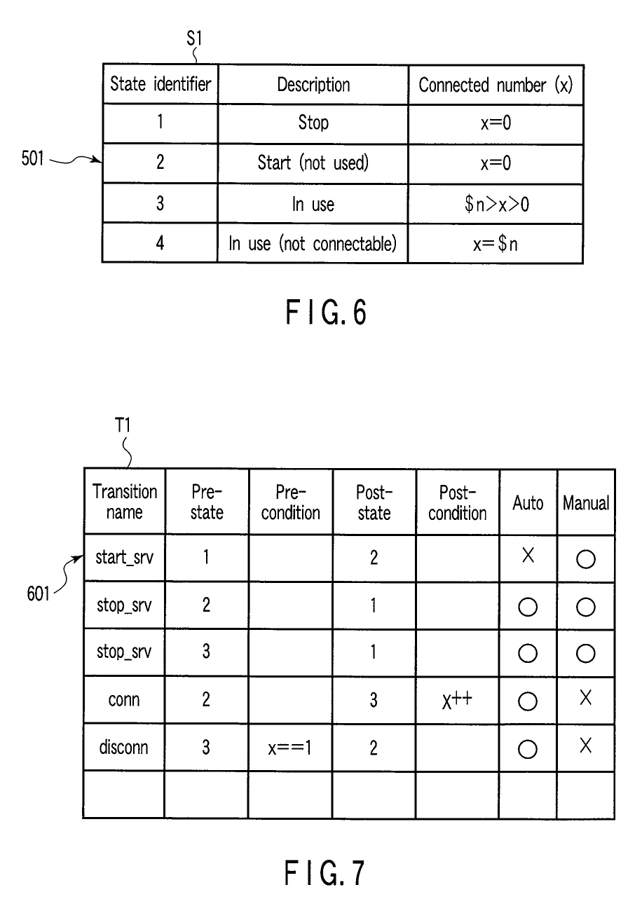

As an example of the state information, the state information specified by the identifier S1, i.e., the state information of the server module 203, is shown in FIG. 6. The state information represents the information on the state that the related module may assume. Data 501 of the state information, for example, indicates that the state specified by a state identifier 2, though activated, is the one not used by any other module. The parameters such as the connected number (x) and the maximum connected number (n) in FIG. 6 may be added to the state information. Also, the character “$” added to the maximum connected number (n) is a flag indicating that the maximum connected number (n) is required to be designated by the user through the analyzer terminal 31 at the time of starting the analysis.

As an example of the transition information, the transition information specified by the identifier T1, i.e. the transition information of the server module 203 is shown in FIG. 7. The transition information is the information on the transition of the related module and includes state transition information indicating the transition between a plurality of states and classification information indicating whether the particular transition is automatic or manual. Data 601 of the transition information, for example, indicates that the transition named “start_srv” is the state transition of the server module 203, which is the transition to the state (post-state=2) identified by the state identifier 2, from the state (pre-state=1) specified by the state identifier 1, and that the transition is not caused automatically (auto=x) but by manual operation (manual=O). The transition information may contain, as shown in FIG. 7, for example, an item relating to the pre-condition or the post-condition and store the conditions before and after transition using the parameter for the state information described above. Incidentally, the state information and the transition information explained above may be realized either as separate information (files) from each other or as integrated information (file).

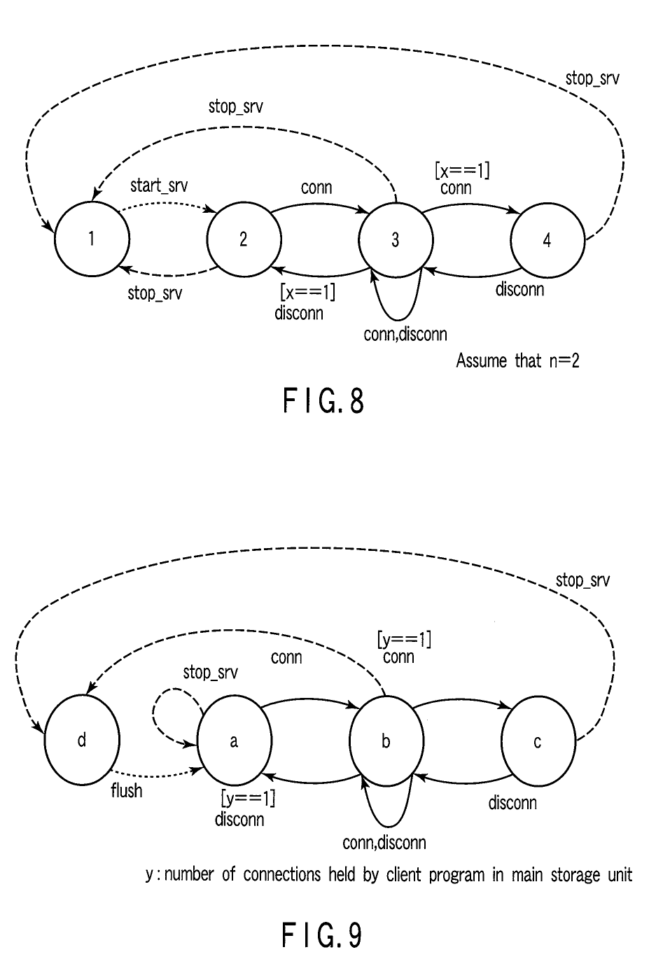

In FIG. 8, the state information and the transition information of the server module 203 used in this embodiment are shown in the form of a state transition diagram. In FIG. 8, the transition designated by solid lines automatically occurs, while the transition designated by dotted lines is manually caused. Incidentally, the formula defined by adding “[ ]” before the transition name represents the pre-condition for the occurrence of the transition.

FIG. 9 is a state transition diagram similar to FIG. 8 and shows the state information and the transition information of the client module 103 according to this embodiment. In FIG. 9, a state “a” is the one in which the computer 200 (server) is not connected, a state “b” the one in which the connection with the server module 203 is held, a state “c” the one in which the maximum number of connections with the server module 203 is held, and a state “d” the one in which an ineffective connection is held. Also, a parameter “y” designates the maximum number of connections held by the client module 103.

Next, with reference to FIG. 10, the steps of the process in which the information system to be analyzed by the information system analysis apparatus according to this embodiment is analyzed will be explained. First, the user inputs information to be analyzed, using the analyzer terminal 31 (S901). The analysis apparatus 32 receives the information to be analyzed from the analyzer terminal 31 and analyzes an anomalous state (S902) and carries out a management work analysis (S903). The analysis result is transmitted to the analyzer terminal 31, and displayed to the user through the analyzer terminal 31 (S904).

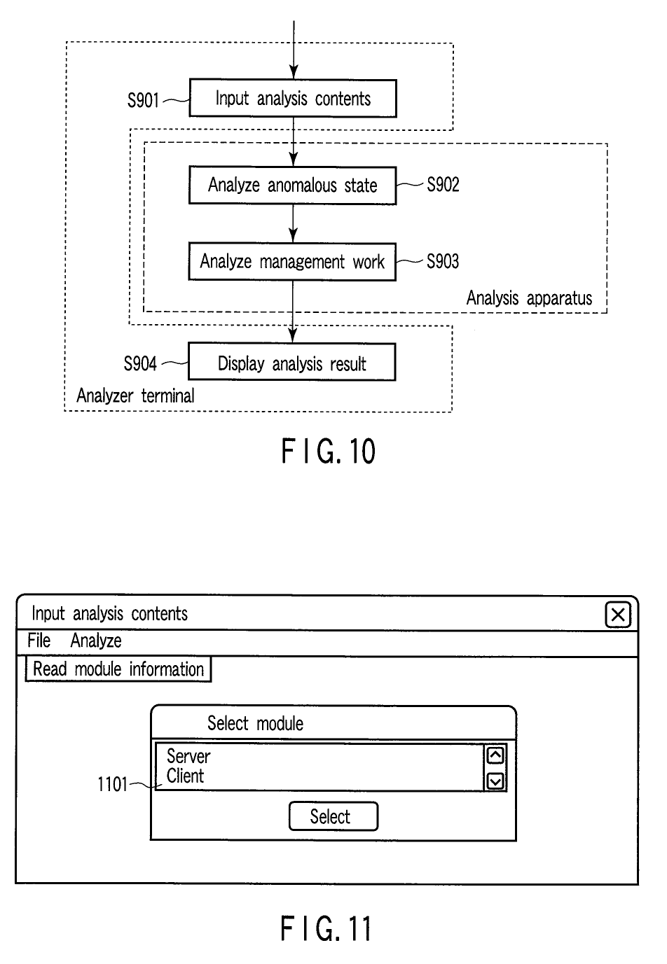

FIGS. 11 to 15 show the manner in which the information to be analyzed is input. According to this embodiment, the information to be analyzed is input using a GUI (graphical user interface) shown in these diagrams. The information to be analyzed includes configuration information, initial state information and restriction information. According to this embodiment, the analyzer terminal 31 is configured to display by acquiring module state transition information 320 from the information system analysis apparatus 32. The analyzer (person in charge of analysis) inputs the information to be analyzed, with reference to the information displayed on the analyzer terminal 31.

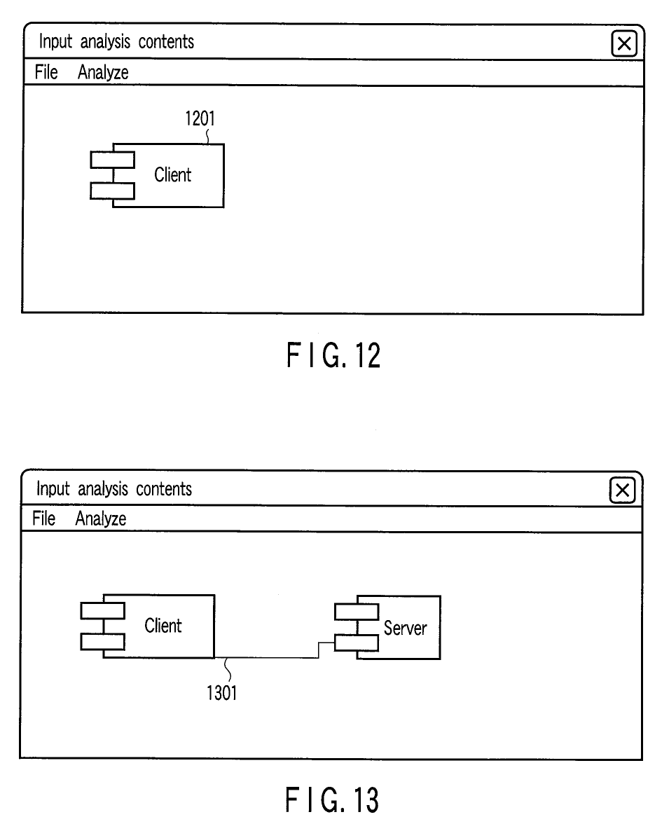

The module information contained in the module state transition information 320 can be identified by the module name. As shown in FIG. 11, the module name is displayed in a module selection list 1101 and thus the user is assisted in inputting the configuration information. The user selects the module making up the system to be analyzed from the module names displayed. FIG. 12 shows a case in which a client 1201 is selected on the screen of FIG. 11. This client 1201 corresponds to the client module 103 shown in FIG. 1. In this manner, the user can designate the module making up the system to be analyzed. Further, according to this embodiment, connection 1301 between the selected modules can be designated. As shown in FIG. 13, for example, the presence of the connection 1301 between the client module 103 and the server module 203 is schematically shown on the screen for input of the information to be analyzed.

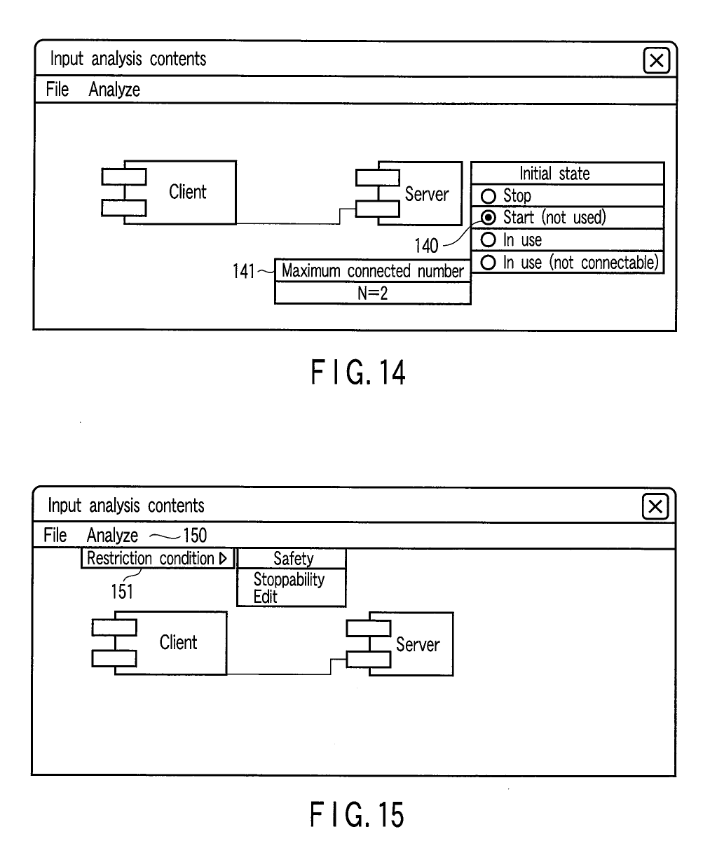

FIG. 14 illustrates the manner in which the information on the module state is designated. In FIG. 14, the fact that the initial state of the server module 203 is “activated” (the state specified by the state identifier 2 in FIG. 6) is designated using a radio button 140. Also, the fact that the maximum connected number of the server module 203 is “2” is designated in a dedicated window 141. Though not shown in FIG. 14, the initial state and the maximum connected number held are designated also for the client module 103. Although this embodiment assumes the input using a GUI, other interfaces may alternatively be used for input as long as similar information can be input. Further, in order to improve the utility for the user, the analyzer terminal 31 may have the function of retrieving possibly related information on the module from the module state transition information storage unit 320 of the analysis apparatus 32. Incidentally, according to this embodiment, the initial state of the server module 203 is assumed to be “activated” (state “2” in FIG. 8), the maximum number of connected server modules 203 to be “2”, the initial state of the client module 103 to be “the state disconnected with the server” (state “a” in FIG. 9) and the maximum number of connections held for the client module 103 to be “2”.

Upon complete input of the initial state, etc. shown in FIG. 14, the user designates a restriction condition (menu) 151 from an analysis menu 150 as shown in FIG. 15, and transmits the information to be analyzed to the analysis apparatus 32. The restriction condition that can be designated includes “safety”, i.e. “not stopped in an unintended state” or “termination”, i.e. “not involved in an unintended loop”. Also, other restrictions can be designated by the temporal logic or the like method. Incidentally, this embodiment assumes that the guarantee of safety is designated.

As described above, this embodiment assumes that the connection between the server module 203 and the client module 103 is designated as the configuration information, that the initial state “activated” (state “2” in FIG. 8) of the server module 203 and “disconnected” (state “a” in FIG. 9) of the client module 103 are designated as the initial state information, and that “safety guaranteed” is designated as the restriction information. Incidentally, the restriction information “safety guaranteed” is to guarantee that the system is not deadlocked, i.e. not stopped in a given state and becomes inoperative.

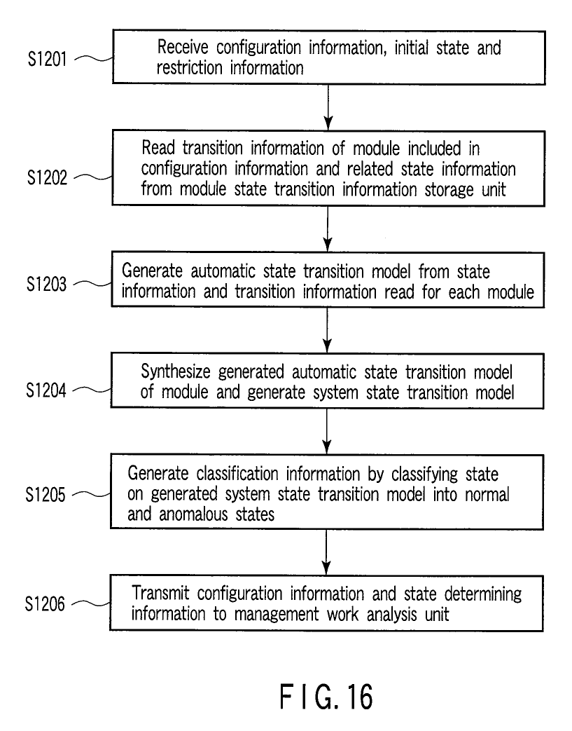

Next, the anomalous state analysis (S902 in FIG. 10) will be explained with reference to FIGS. 16 to 20. FIG. 16 shows the flow of the process executed by an anomalous state analysis unit 321. The anomalous state analysis unit 321 first receives the configuration information, the initial state information and the restriction information from the analyzer terminal 31 (S1201), and then reads the state information and the transition information of the related module from the module state transition information storage unit 320 (S1202). The related module is a module designated in the configuration information received by the anomalous state analysis unit 321.

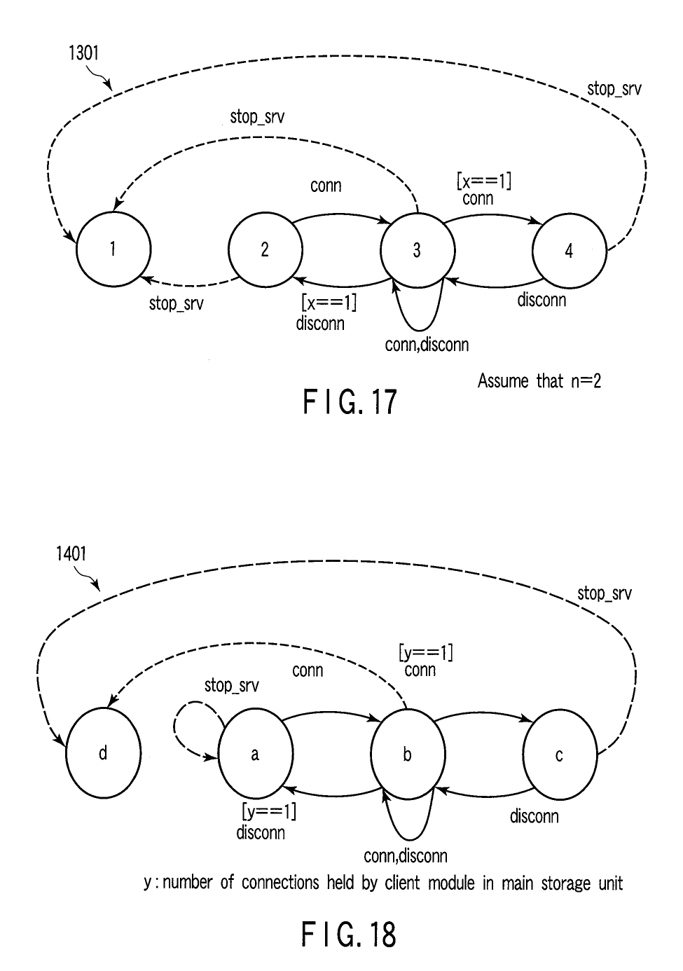

According to this embodiment, the state information and the transition information are read for each of the server module 203 and the client module 103. Then, based on the state information and the transition information, the state transition model for each module configured of only the automatic transition (hereinafter referred to as “the automatic state transition model”) is generated (S1203). Specifically, from the data on the transition information that have been read, a state transition model including the transition with “auto=O” and the state before or after the particular transition is generated. According to this embodiment, a state transition model 1301 shown in FIG. 17 is generated as an automatic state transition model of the server module 203, and a state transition model 1401 shown in FIG. 18 is generated as a management state transition model of the client module 103.

Next, a system state transition model is generated by synthesizing the automatic state transition models 1301, 1401 for each module generated in step S1203 (S1204). The state transition models are synthesized taking the transition name appearing on all the plurality of module state transition models into consideration. Incidentally, for the details of the synthesis, refer to “Concurrency State Models & Java (registered trademark) Programming, Jeff Magee and Jeff Kramer, John Wiley & Sons Inc.”.

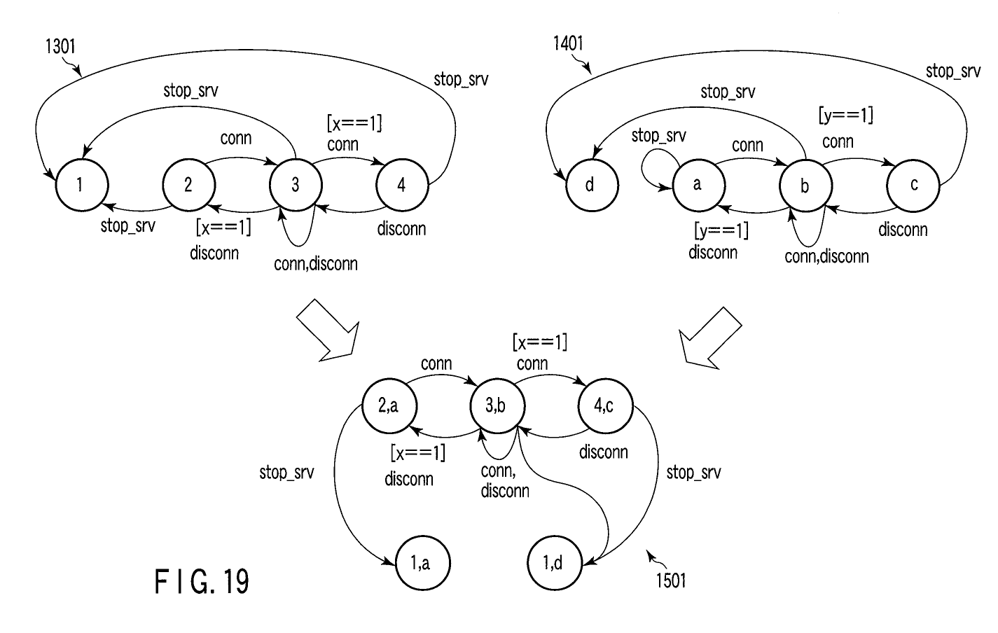

The synthesis of the state transition models according to this embodiment is shown in FIG. 19. Incidentally, the state in the system state transition model is described in the form of (state of server module 203, state of client module 103). According to this embodiment, the initial states of the server module 203 and the client module 103 are designated as “2” and “a”, respectively, and therefore, the initial state in a system state transition model 1501 after synthesis is expressed as (2, a).

Next, the transition from the state (2, a) will be explained. The transition appearing in both the state transition model 1301 of the server module 203 and the state transition model 1401 of the client module 103 at the same time is regarded as the transition shared by these two state transition models. Assuming that transition “conn” occurs with the system state of (2, a), for example, the transition “conn” is assumed to occur in both the server module 203 and the client module 103. In this case, therefore, the system state transition occurs from (2, a) to (3, b). Based on this assumption, the state transition model 1301 of the server module 203 and the state transition model 1401 of the client module 103 are synthesized. Then, the system state transition model 1501 is generated as shown in FIG. 19.

Next, the state on the system state transition model 1501 thus generated is classified into the normal state and the anomalous state in accordance with the restriction information received from the analyzer terminal 31 (S1205). In the process, the state satisfying the restriction designated by the restriction information is regarded as a normal state, and the state failing to satisfy the same restriction as an anomalous state. The restriction information indicates the restriction to be satisfied in the case where the information system to be analyzed is normal.

According to this embodiment, the safety guarantee is designated as the restriction condition as described above. The state in which safety is guaranteed in the state transition model is considered “a given state in which the transition to another state is existent”. Strictly speaking, the definition of safety is different from this. Nevertheless, this definition is used for simplification in this embodiment.

Referring to the system state transition model 1501, it is understood that the states (2, a), (3, b) and (4, c) represent normal states having the transition to another state, while the states (1, a) and (1, d) are anomalous states.

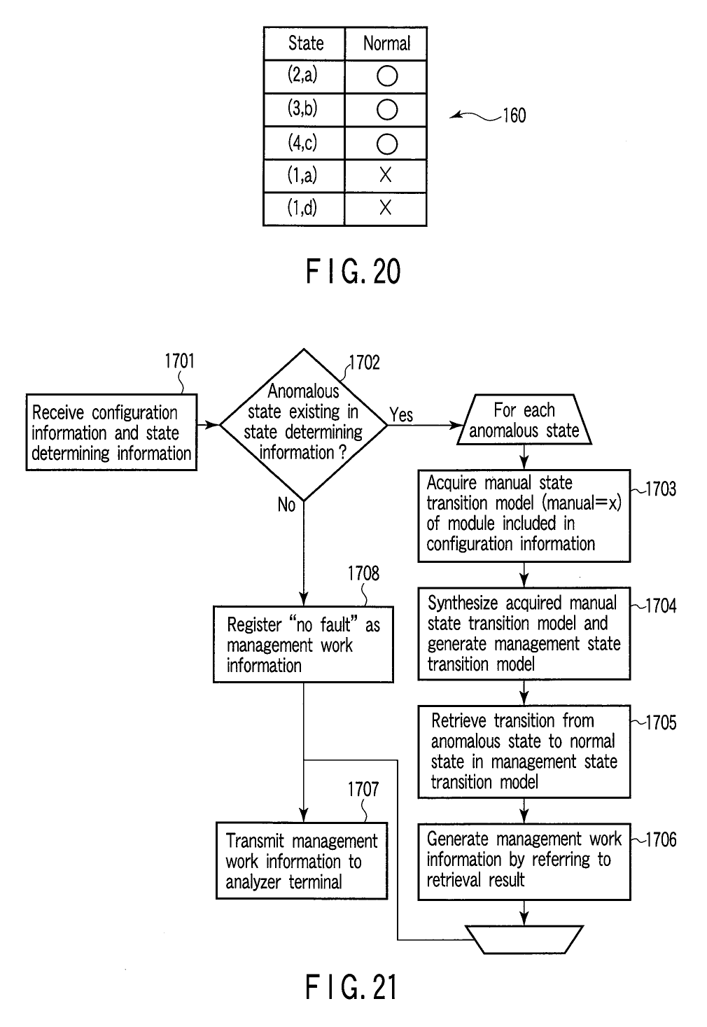

From this classification result, state classification information is generated in step S1205. The state classification information according to this embodiment is shown in FIG. 20. The state classification information 160 indicates whether each state of the system is normal or not. In the state classification information 160 shown in FIG. 20, the state in which the item “normal” is “O” is a normal state, and the state in which the item “normal” is “x” is an anomalous state.

The anomalous state analysis unit 321 finally transmits the state classification information 160 thus generated to the management work analysis unit 322 (S1206).

Next, the management work analysis (S903 in FIG. 10) will be explained with reference to FIGS. 21 to 25. FIG. 21 shows the flow of the process executed in the management work analysis unit 322. The management work analysis unit 322 first receives the configuration information and the state classification information 160 from the anomalous state analysis unit 321 (S1701).

Next, the state classification information 160 received from the anomalous state analysis unit 321 is checked for any state determined as an anomalous state (S1702). In the absence of any anomalous state in the state classification information 160, the management work information is registered as the one having no anomaly (S1708).

In the presence of an anomalous state in the state classification information 160, on the other hand, the process of steps S1703 to S1706 is repeated for each anomalous state. According to this embodiment, the process of steps S1703 to S1706 is executed for the states (1, a) and (1, d).

Now, the process of steps S1703 to S1706 for the state (1, d) will be explained.

First, the state information and the transition information of the module contained in the configuration information are read from the module state transition information storage unit 320 in step S1703, and based on the state information and the transition information, the state transition model for each module configured of only the manual transition (hereinafter referred to as “the manual state transition model”) is generated. Specifically, from the data of the transition information that have been read, a state transition model including the transition with the item “manual” of “O” and the state before or after the transition is generated.

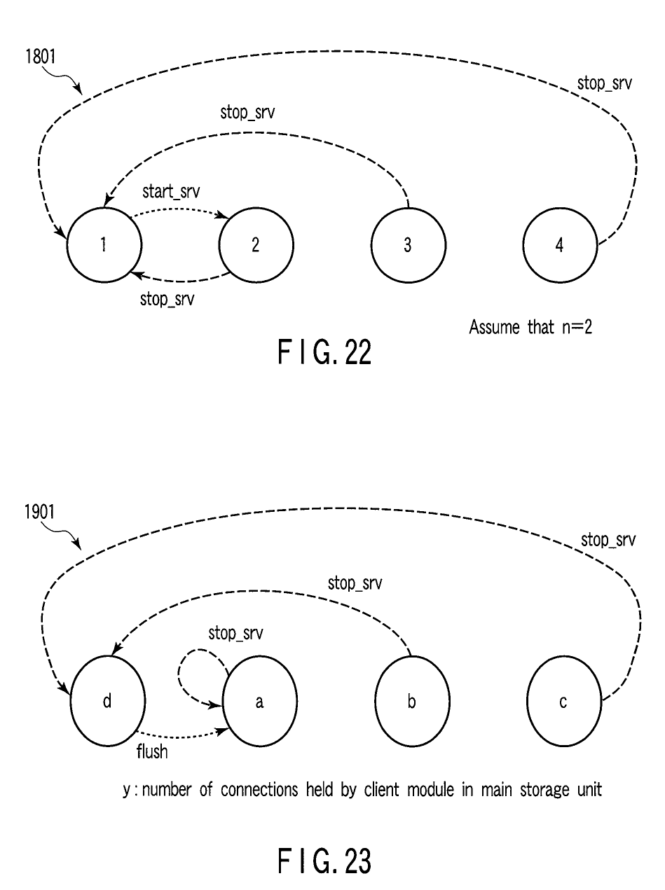

FIG. 22 shows a manual state transition model 1801 of the server module 203, and FIG. 23 a manual state transition model 1901 of the client module 103.

Next, the manual state transition models 1801, 1901 for each module generated in step S1703 are synthesized thereby to generate a management state transition model (S1704).

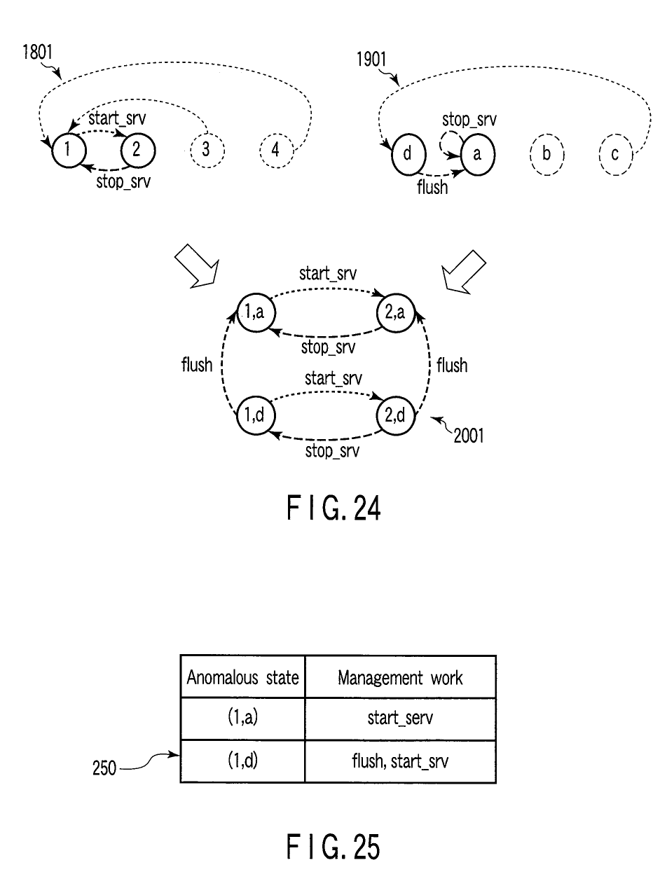

FIG. 24 shows the manner in which the management state transition model is generated by synthesis. The state transition models are synthesized with the intended anomalous state as the initial state in a similar manner to the system state transition model explained with reference to FIG. 19.

Consider the state (1, d) as the initial state. A management state model 2001 shown in FIG. 24 is generated. Incidentally, in the manual state transition models 1801, 1901 shown in FIG. 24, a state (3, 4, b, c) indicated by dashed lines is the transition that cannot be reached in the initial state (1, d), and therefore, can be ignored for synthesis.

Then, the management state model 2001 generated is accessed, and the transition to the normal state from the intended anomalous state is retrieved (S1705). Now, referring to state determining information shown in FIG. 20, it is understood that the state (2, a) is the normal state in the management state transition model 2001. For transition from the state (1, d) which is the present intended anomalous state to the state (2, a), therefore, it is understood that the transitions are required which can be identified by the transition name “start_srv” and the transition name “flush”. Therefore, the retrieval result “start_srv” and “flush” are registered. Incidentally, in the case where the retrieval ends in a failure, “retrieval failure” is registered as a retrieval result.

Next, referring to the transition retrieval result, management work information is generated. The management work information is stored with the anomalous state related to the management work for the anomalous state. Management work information 250 finally registered in this embodiment is shown in FIG. 25. For example, data 2101 shown in FIG. 25 indicates that the anomalous state (1, d) requires the management work corresponding to the transition name “flush” and the transition name “start_srv”.

Upon completion of the process of steps S1703 to S1706 against all the anomalous states included in the state classification information 160, the management work information 250 generated is transmitted to the analyzer terminal 31 (S1707). The analyzer terminal 31, upon reception of the management work information 250, displays the management work information 250 in an appropriate form.

According to the embodiment explained above, the anomalous state (i.e. “fault”) and the management work required for the anomalous state can be presented to the user by relating them to each other. As a result, the user can grasp an anomalous state which may occur in the information system managed by the user and the management work required upon occurrence of the anomalous state, before the particular anomalous state actually occurs. Thus, the maintenance and management of the information system are facilitated.

Also, though not explained in this embodiment, the information for relating a module state to the operation required for specifying the particular state and the information for relating a transition name to the actual management work corresponding to the particular transition are stored in the storage unit, and retrieval means for retrieving these types of information is preferably arranged at the analyzer terminal 31 or the like, which further facilitates the maintenance and management of the information system.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A system analysis apparatus for an information system to be analyzed, comprising:
a storage unit which stores state information indicating a plurality of states of the system identified by state identifiers, and transition information including state transition information indicating a transition between said plurality of states and classification information indicating whether the transition is an automatic one or a manual one;
an analysis unit configured to acquire restriction information indicating a restriction to be satisfied in the case where the information system is normal and to specify an anomalous state of the information system failing to satisfy the restriction based on the restriction information acquired and the transition information; and
an output unit configured to retrieve the transition from the anomalous state specified by the analysis unit to the normal state, based on the state information and the transition information, to generate a management work with reference to the retrieval result, and to output management work information indicating the generated management work as related to the anomalous state.

2. The apparatus according to claim 1,
wherein the analysis unit generates an automatic state transition model indicating the state transition involving only the automatic transition, and outputs state classification information indicating a plurality of states held by the automatic state transition model, as classified into a normal state satisfying the restriction and an anomalous state failing to satisfy the restriction.

3. The apparatus according to claim 1,
wherein the analysis unit generates a manual state transition model indicating the state transition involving only the manual transition, and retrieves the transition from the anomalous state to the normal state for the manual state transition model.

4. A system analysis apparatus for each of a first module and a second module included in an information system to be analyzed, comprising:
a storage unit which stores state information indicating a plurality of states of the system identified by state identifiers, and transition information including state transition information indicating a transition between said plurality of states and classification information indicating whether the transition is an automatic one or a manual one;
a first synthesis unit configured to generate an automatic state transition model by synthesizing a state transition involving only the automatic transition in the first module with a state transition involving only the automatic transition in the second module;
an analysis unit configured to acquire restriction information indicating a restriction to be satisfied in the case where the information system is normal and to specify an anomalous state failing to satisfy the restriction in the automatic state transition model;
a second synthesis unit configured to generate a manual state transition model by synthesizing a state transition involving only the manual transition in the first module with a state transition involving only the manual transition in the second module; and
an output unit configured to retrieve the transition from the anomalous state specified by the analysis unit to the normal state in the manual state transition model, to generate a management work with reference to the retrieval result, and to output the management work information indicating the generated management work as related to the anomalous state.

5. The apparatus according to claim 4,
wherein the analysis unit outputs state classification information indicating a plurality of states held in the automatic state transition model, as classified into a normal state satisfying the restriction and an anomalous state failing to satisfy the restriction.

6. The apparatus according to claim 4,
wherein the analysis unit retrieves the transition from the anomalous state to the normal state for the manual state transition model.

7. A system analysis method for an information system to be analyzed, the method comprising:
storing state information indicating a plurality of states of the system identified by state identifiers, and transition information including state transition information indicating a transition between said plurality of states and classification information indicating whether the transition is an automatic one or a manual one;
acquiring restriction information indicating a restriction to be satisfied in the case where the information system is normal and specifying an anomalous state of the information system failing to satisfy the restriction based on the restriction information acquired and the transition information;
retrieving the transition from the anomalous state to the normal state based on the state information and the transition information, and generating a management work with reference to the retrieval result; and
outputting management work information indicating the management work as related to the anomalous state.

8. The method according to claim 7, further comprising:
generating an automatic state transition model indicating the state transition involving only the automatic transition; and
outputting state classification information indicating a plurality of states held in the automatic state transition model, as classified into a normal state satisfying the restriction and an anomalous state failing to satisfy the restriction.

9. The method according to claim 7, further comprising:
generating a manual state transition model indicating the state transition involving only the manual transition; and
retrieving the transition from the anomalous state to the normal state for the manual state transition model.

10. A system analysis method for each of a first module and a second module of an information system to be analyzed, the method comprising:
storing state information indicating a plurality of states of the system identified by state identifiers, and transition information including state transition information indicating a transition between said plurality of states and classification information indicating whether the transition is an automatic one or a manual one;
generating an automatic state transition model by synthesizing a state transition involving only the automatic transition in the first module with a state transition involving only the automatic transition in the second module;
acquiring restriction information indicating a restriction to be satisfied in the case where the information system is normal and specifying an anomalous state failing to satisfy the restriction in the automatic state transition model;
generating a manual state transition model by synthesizing a state transition involving only the manual transition in the first module with a state transition involving only the manual transition in the second module;
retrieving the transition from the anomalous state to the normal state in the manual state transition model and generating a management work with reference to the retrieval result; and
outputting management work information indicating the management work as related to the anomalous state.

11. The method according to claim 10, further comprising:
outputting state classification information indicating a plurality of states held in the automatic state transition model, as classified into a normal state satisfying the restriction and an anomalous state failing to satisfy the restriction.

12. The method according to claim 10, further comprising:
retrieving the transition from the anomalous state to the normal state for the manual state transition model.

13. A computer-readable recording medium having recorded therein a computer program for system analysis, wherein the computer program, when executed by a computer, performs the steps of:
storing, for an information system to be analyzed, state information indicating a plurality of states of the system identified by state identifiers, and transition information including state transition information indicating a transition between said plurality of states and classification information indicating whether the transition is an automatic one or a manual one;
acquiring restriction information indicating a restriction to be satisfied in the case where the information system is normal and specifying an anomalous state of the information system failing to satisfy the restriction based on the restriction information acquired and the transition information;
retrieving the transition from the anomalous state to the normal state based on the state information and the transition information, and generating a management work with reference to the retrieval result; and
outputting management work information indicating the management work as related to the anomalous state.

14. A computer-readable recording medium having recorded therein a computer program for system analysis, wherein the computer program, when executed by a computer, performs the steps of:
storing, for each of a first module and a second module of an information system to be analyzed, state information indicating a plurality of states of the system identified by state identifiers, and transition information including state transition information indicating a transition between said plurality of states and classification information indicating whether the transition is an automatic one or a manual one;
generating an automatic state transition model by synthesizing a state transition involving only the automatic transition in the first module with a state transition involving only the automatic transition in the second module;
acquiring restriction information indicating a restriction to be satisfied in the case where the information system is normal and specifying an anomalous state failing to satisfy the restriction in the automatic state transition model;
generating a manual state transition model by synthesizing a state transition involving only the manual transition in the first module with a state transition involving only the manual transition in the second module;
retrieving the transition from the anomalous state to the normal state in the manual state transition model and generating a management work with reference to the retrieval result; and
outputting management work information indicating the management work as related to the anomalous state.
